(19) United States
(12) Patent Application Publication
(10) Pub. No.: US 2009/0179911 A1
(43) Pub. Date: Jul. 16, 2009

(54) METHOD FOR CODING A COLOUR DIGITAL IMAGE COMPRISING WEIGHTING INFORMATION

(75) Inventor: Eric Filliatre, Merignac (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/298,175

(22) PCT Filed: Apr. 20, 2007
(86) PCT No.: PCT/EP2007/053910

§ 371 Date: Oct. 23, 2008

(30) Foreign Application Priority Data
Apr. 26, 2006 (FR) 0603735

(51) Int. Cl. G09G 5/02

(52) U.S. Cl. 345/600

(57) ABSTRACT

The field of the invention is that of display systems comprising graphics generation systems. The field of privileged application is that of overlaying synthetic symbologies coming from graphics generation systems onto one or more video images. The invention relates notably to display systems on board aircraft. The invention relates more specifically to a method for coding pixels of a color digital image, each colored pixel being coded over three digital components each comprising the same number of bits, wherein at least one of the coded components comprises a piece of color information on the one hand and a piece of weighting information on the other hand, said piece of weighting information being intended to be used by image processing algorithms of the digital filtering or antialiasing type.

### CROSS-REFERENCE TO RELATED APPLICATIONS

The present Application is based on International Application No. PCT/EP2007/053910, filed on Apr. 20, 2007, which in turn corresponds to French Application No. 0603735, filed on Apr. 26, 2006, and priority is hereby claimed under 35 USC §119 based on these applications. Each of these applications are hereby incorporated by reference in their entirety into the present application.

### FIELD OF THE INVENTION

The field of the invention is that of display systems comprising graphics generation systems. The field of privileged application is that of overlaying synthetic symbologies coming from graphics generation systems onto one or more video images. The invention relates notably to display systems on board aircraft.

### DESCRIPTION OF THE PRIOR ART

A digital color image is conventionally composed of elementary color pixels. Each colored pixel is coded over three digital components, each comprising the same number of bits, each component corresponding to a primary color, generally red, green or blue, also denoted by the term “RGB” components.

For a certain number of applications, in particular in the aeronautical field, it may be necessary, as indicated in FIG. 1, to overlay a first electronic image coming from an image sensor 5 with a second image coming from a graphics generation system 1 comprising an image memory 2. The two electronic images are merged by electronic means before being sent to a display screen 4. This is the case notably in the aeronautical field where it is necessary to superpose information necessary for piloting or aerial navigation on an image of the external scenery.

However, if it is desired to obtain a quality overlay in which the overlaid image preserves good readability and good contrast, it is not possible simply to add or superpose the images. Thus if a segment of a certain thickness of a first initial color is generated on a background of a second initial color, steps are obtained due to the effect of applying the method known as “antialiasing” to the segment. Even if the size of the screen pixel is small, these steps are seen by the user and constitute a visual inconvenience. To reduce this visual effect, a method of color combination is generally used which consists, for the pixels located at the borders of the segment, in mixing the color of the segment with the color of the background by applying a mixing rule, as a function of a transparency law depending on an alpha transparency factor A and the initial colors of the segment and the background. In this case, it is necessary for each pixel additionally to comprise RGB calorimetric information, a piece of weighting information denoted by a capital “A”. In this case the pixels comprise four components RGBA. Currently, most of the onboard synthetic graphics generation solutions for commercial applications are so-called “proprietary” solutions, i.e. solutions completely handled by the designer of the graphics generation system. In this case, the four RGBA components are, by design, handled all along the calculation chain and conserved in the image memories so as to deliver them to any external resource providing the overlaying with one or more sensor videos.

However, the evolution of technologies, the increasingly large development costs, and the performance levels required to respond to the demands of new programs are leading the various producers of equipment in the aeronautical field to employ GPU-COTS components, the acronym meaning Graphic Processing Unit—Commercial Off The Shelf. Thus the graphics generation system is based on a non-dedicated graphics processor based on the current OpenGL graphics standards. OpenGL, the acronym for Open Graphics Library, is a multiplatform programming interface for the design of applications generating two- or three-dimensional images. This interface brings together different functions that can be used to display complex three-dimensional scenes from simple primitives.

Yet the field of use of these components does not include the need for the external resources to overlay a synthetic image on one or more sensor videos. Consequently, these components do not retrieve the alpha component from the image memory and therefore do not provide the alpha component at their digital video output, which does not allow a quality overlay.

The aim of the method according to the invention is to provide, at the output from the synthetic graphics generation system, all the information enabling realization of a quality overlay on a sensor video over only the three components usually used. The information to be provided for each pixel is the RGB color information and the alpha component that corresponds to the weighting factor of the color necessary for the antialiasing or filtering algorithms.

The aim of this method is to be generic in relation to the current graphics standards, and not to depend on specific features of certain components such as the availability of two independent digital video outputs which, by plotting the same image on each channel in slightly different graphics modes, enables the output of RGB on one channel and the alpha factor on another channel.

This method is essentially applicable when the overlay is produced by a resource external to the synthetic graphics generation system. The need for this external resource derives from the multitude of potential sensor video formats to be processed, and from the various refresh rates of the videos.

The method according to the invention applies notably when the synthetic graphics generation system is based on a non-dedicated COTS graphics processor based on the current OpenGL graphics standards.

### SUMMARY OF THE INVENTION

More specifically, the subject of the invention is a method for coding pixels of a color digital image, each colored pixel being coded over three digital components each comprising the same number of bits, characterized in that at least one of the coded components comprises a piece of color information on the one hand and a piece of weighting information on the other hand, said piece of weighting information being intended to be used by image processing algorithms of the digital filtering or antialiasing type.

The components are advantageously coded over eight bits, at least one of the components comprising a piece of color information coded over 5 bits and a piece of weighting information coded over 3 bits, the color information is coded over the MSBs, or Most Significant Bits.

The method advantageously comprises at least four steps:
a first step consisting in only coding the color information of each component over a number of bits lower than the total number of bits of said component;
a second step consisting in positioning the color information on the MSBs (Most Significant Bits) of each component;
a third step consisting in coding the weighting information over a number of bits equal to the difference between the total number of bits of a component minus the number of bits corresponding to the color information;
a fourth step consisting, for at least one of the components, in positioning the weighting information on the LSBs (Least Significant Bits) not used by the color information coding.

Advantageously, the second step is carried out by adding the value of the bits of each component to itself at least once.

The invention also relates to an electronic digital image generation device comprising a calculation unit of the GPU (Graphics Processing Unit) type, characterized in that it comprises a coding method having one of the preceding features.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 shows the general overview of a display system enabling image overlay;

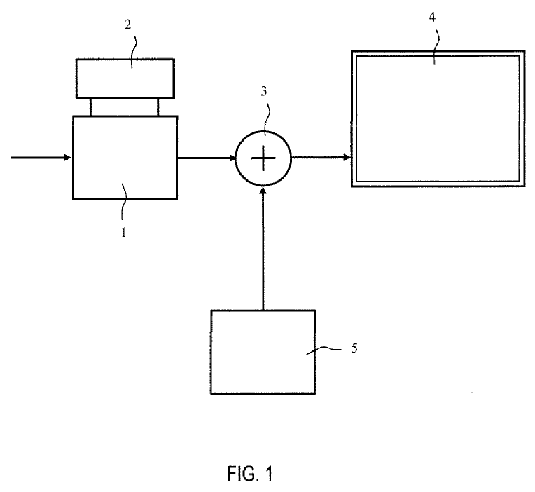

FIG. 2 shows two steps of the method according to the invention; and

FIG. 3 shows the detail of the operations carried out in the course of the second step.

### DETAILED DESCRIPTION OF THE INVENTION

The basic principle of the invention consists in exploiting only the generic graphics resources available on standard OpenGL image generation systems. Consequently, the coding method according to the invention consists in coding the three pieces of information necessary for the color and the weighting information over the three standard components conventionally used to code only the color.

In order for this method to be applied, three conditions must be satisfied:
the graphics generation system must provide the image in a digital video format in which the colors are represented by their three color components, for example RGB (Red, Green and Blue) components;
it is possible to code the useful colors used by the elements constituting the image over a number of bits less than that available at the output of the graphics generation system; and
a minimum of three bits must suffice to define the alpha parameter and thus to produce an overlay of symbology onto the sensor video with sufficient quality.

These three conditions are generally satisfied. In fact, the digital video outputs from current standard graphics generation systems offer 8 bits as a standard per RGB component. Conventionally, the least significant bits are known by the acronym LSBs, and the most significant bits are known by the acronym MSBs. Yet it is obvious that the coding of the color pixels of a symbology does not require a color range as large as that of a real image. Generally, several tens of colors suffice to code all the characters and symbols. It is hence possible to code the useful colors by only using a limited number of bits of each component. By way of example, one configuration type may be:
5 bits over the red LSBs;
6 bits over the green LSBs; and
5 bits over the blue LSBs.

Thus at least 3 bits remain available on at least two of the components. Conversely, the weighting information coding requires only a limited number of bits, 3 bits generally sufficing. Thus it is possible to code color information and weighting information on the same component at the same time.

The various steps of the method consist in working out the sequence of graphics operations that lead to the insertion, for each pixel, of the value of alpha stored in the image memory at the location of the bits not used in the RGB color components, while taking account of the constraints and the particular rules linked with the use of graphics processors.

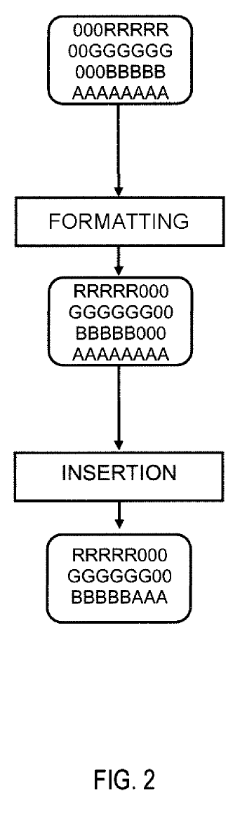

Overall, as illustrated in FIG. 2, the method according to the invention comprises two main steps, which are, on the one hand, a step of formatting the color components of each pixel and a step of inserting the weighting information into at least one of the color components. In the case of FIG. 2, each pixel comprises three color components coded over 8 bits, symbolically marked by the series of capital “R”s, “G”s or “B”s, and a weighting component coded over 8 bits symbolically marked by a series of “A”s, the zero bits being marked “0”.

In greater detail, and by way of example, when it is implemented in a GPU, the whole of the method comprises 4 steps, marked 1, 2, 3 and 4, which are:

Step 1: Each symbol is generated conventionally in the image memory of the GPU in the RGBA format;

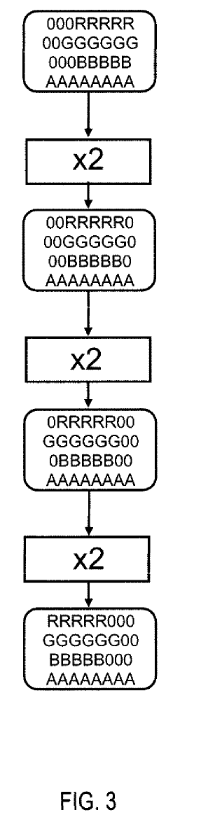

Step 2: This step is illustrated in FIG. 3. All the useful bits of the RGB components written in the image memory are shifted to the MSBs (Most Significant Bits) of each component. The technique used consists in plotting, as many times as there are shifts to be carried out, a surface or a set of surfaces:
that cover the surface of the image in a unique manner;
that will be subjected to a color mixing law such that each RGB component of each pixel resulting from the mixing law in the image memory is the result of adding each source component from the image memory to itself. This operation amounts to carrying out a multiplication of each component affected by two;
that are allocated with a color defined according to the following criteria:
   a color component R, G or B positioned at the maximum value, which will be 255 or 1.0 depending on the unit chosen, will lead to the application of the mixing law over all the corresponding pixel components from the image memory; and
   a color component R, G or B positioned at the minimum value, which will be 0 or 1.0 depending on the unit, will lead to no effect of the mixing law over all the corresponding pixel components from the image memory.

Step 3: When the useful bits of the color components have been positioned on the MSBs, this step consists in converting, linearly and for each pixel, the 8-bit alpha value contained in the image memory into a 3-bit value;

Step 4: The 3-bit converted value is injected for each pixel into the unused LSBs of, according to preference, an R or B color component. The technique used consists in plotting a surface or a set of surfaces:
that cover the surface of the image in a unique manner;
that will be subjected to a color mixing law such that:
   each component of the object plotted is weighted for each pixel by the alpha from the image memory;
   each resulting component is added for each pixel to that corresponding from the image memory;
that are allocated with a color to which the alpha weighting will be applied:
   the active bits must be positioned in the unused bits of the color component from the image memory in which the alpha will be inserted. It is possible to carry out this operation on the most suitable R or B component;
   the value interval of the component must be equal to the number of unused bits on the target component, 3 bits in the case of FIG. 3.

Once the coding has been carried out, the image memory is re-read by the graphics generation system, which then provides for each pixel at the digital video output the combination of the RGB color information and the alpha information.

Of course, the decoding and the separation of the color information and the weighting information do not pose a particular technical problem.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method for coding pixels of a color digital image, each colored pixel being coded over three digital components each comprising the same number of bits, wherein at least one of the coded components comprises a piece of color information and a piece of weighting information, said piece of weighting information to be used by image processing algorithms of the digital filtering or antialiasing type, the color information being coded over most significant bits.

2. The coding method as claimed in claim 1, wherein the components are coded over eight bits, at least one of the components comprising a piece of color information coded over 5 bits and a piece of weighting information coded over 3 bits.

3. The coding method as claimed in claim 1, comprising at least four steps:
a first step comprising only coding the color information of each component over a number of bits lower than the total number of bits of said component;
a second step comprising positioning the color information on the MSBs (Most Significant Bits) of each component;
a third step comprising coding the weighting information over a number of bits equal to the difference between the total number of bits of a component minus the number of bits corresponding to the color information;
a fourth step comprising, for at least one of the components, in positioning the weighting information on the LSBs (Least Significant Bits) not used by the color information coding.

4. The coding method as claimed in claim 3, wherein the second step is carried out by adding the value of the bits of each component to itself at least once.

5. An electronic digital image generation device comprising a calculation unit of the GPU (Graphics Processing Unit) type, comprising a coding method as claimed in claim 1.
